(19) United States
(12) Patent Application Publication
(10) Pub. No.: US 2020/0072593 A1
(43) Pub. Date: Mar. 5, 2020

(54) POSITION SENSOR

(71) Applicant: DENSO CORPORATION, Kariya-city (JP)

(72) Inventors: Atsushi KOBAYASHI, Kariya-city (JP); Yasuhiro KITAURA, Kariya-city (JP); Michihiro MAKITA, Kariya-city (JP); Akito SASAKI, Kariya-city (JP); Tetsuya OHMI, Kariya-city (JP)

(21) Appl. No.: 16/676,645

(22) Filed: Nov. 7, 2019

Related U.S. Application Data
(63) Continuation of application No. PCT/JP2018/019059, filed on May 17, 2018.

(30) Foreign Application Priority Data
Jun. 14, 2017 (JP) 2017-117170

(51) Int. Cl. G01B 7/00; F16H 59/08; F16H 61/02; G01D 5/14; G01D 5/245; G01P 13/02

(52) U.S. Cl. CPC G01B 7/00; F16H 59/08; G01P 13/02; G01D 5/145; G01D 5/245; F16H 61/02

(57) ABSTRACT

A position sensor includes a detector (122) and a signal processor (123). The detector generates detection signals, which have a distinct phase difference and which respectively correspond to ranges aligned in one direction along a movement direction of a detection target (200, 202, 203) having a magnetic material, based on a change in a magnetic field received from the detection target along with a movement of the detection target. The signal processor acquires the detection signals from the detector, compares the detection signals with a threshold value, and specifies a position of the detection target as a position covered by one of the ranges based on a combination of magnitude relations of the detection signals and the threshold value.

### CROSS REFERENCE TO RELATED APPLICATIONS

The present application is a continuation application of International Patent Application No. PCT/JP2018/019059 filed on May 17, 2018, which designated the U.S. and claims the benefit of priority from Japanese Patent Application No. 2017-117170 filed on Jun. 14, 2017. The entire disclosures of all of the above applications are incorporated herein by reference.

### TECHNICAL FIELD

The present disclosure relates to a position sensor.

### BACKGROUND

A linear position sensor may include a permanent magnet, a magnetic field sensor and an evaluation circuit. In this sensor, the permanent magnet and the magnetic field sensor can move relative to each other along a movement path. The magnetic field sensor generates an output signal determined based on the direction of a magnetic field. The evaluation circuit converts the output signal of the magnetic field sensor to a signal, which is directly proportional to the path being measured.

### SUMMARY

The present disclosure describes a position sensor that outputs a signal corresponding to a position of a detection target.

### BRIEF DESCRIPTION OF DRAWINGS

The above and other objects, features and advantages of the present disclosure will become more apparent from the following detailed description when taken in conjunction with the accompanying drawings. In the drawings:

FIG. 1 is an outline drawing of a position sensor according to a first embodiment of the present disclosure;

FIG. 2 is an exploded perspective view of components included in a magnetic detection system using a magnetic resistance element;

FIG. 3 is a plan view of the respective components illustrated in FIG. 2;

FIG. 4 is a cross-sectional view taken along a line IV-IV of FIG. 3;

FIG. 5 illustrates a detection signal from the magnetic resistance element;

FIG. 6 is a plan view of components configuring a magnetic detection system using a Hall-effect sensor;

FIG. 7 is a cross-sectional view taken along a line VII-VII of FIG. 6;

FIG. 8 illustrates a detection signal from the Hall-effect sensor;

FIG. 9 illustrates a circuit configuration of the position sensor;

FIG. 10 illustrates a detection signal, a state determination and a position signal in a case of detecting three states;

FIG. 11 illustrates a case of detecting four states, as a modified example;

FIG. 12 illustrates a case where a detection signal is generated from the output of two element pairs, as a modified example;

FIG. 13 is a diagram showing a case where a detection signal is generated from the output of three element pairs, as a modified example;

FIG. 14 illustrates a case where a detection signal is generated from the output of five element pairs, as a modified example;

FIG. 15 illustrates a case where three detection signals are generated from the output of four element pairs to determine five states, as a modified example;

FIG. 16 illustrates a case where three detection signals are generated from the output of three element pairs to determine six states, as a modified example;

FIG. 17 illustrates a case where four detection signals are generated from the output of four element pairs to determine seven states, as a modified example;

FIG. 18 illustrates a case where four detection signals from the output of five element pairs to determine eight states, as a modified example;

FIG. 19 illustrates a case where two threshold values are used to determine seven states, as a modified example;

FIG. 20 illustrates a case where three states are determined based on the output of three Hall-effect sensors, as a modified example;

FIG. 21 illustrates a modified example of a shaft;

FIG. 22 illustrates an example of a detection target;

FIG. 23 illustrates an example of the detection target;

FIG. 24 illustrates a shaft according to a second embodiment;

FIG. 25 illustrates a detection signal, state determination and a position signal in a case of detecting three states for the shaft as illustrated in FIG. 24;

FIG. 26 illustrates a case of determining four states, as a modified example;

FIG. 27 illustrates an example of the detection target;

FIG. 28 illustrates an example of the detection target; and

FIG. 29 illustrates discrete pulse widths in a case of determining three states according to a third embodiment.

### DETAILED DESCRIPTION

A detection target may be a magnet itself or a magnet mounted on the detection target. Thus, additional manufacturing steps of the detection target or assembly of the magnet is required. The number of manufacturing steps, the number of assembling steps and the number of components increase, and thus a detection positional error may occur. A detection positional error may also occur due to a signal misalignment at the interface unit or an A/D conversion error being included in a directly proportional signal.

In one or more embodiments of the present disclosure, a position sensor suppresses generation of a detection positional error.

A position sensor according to an aspect of the present disclosure includes a detector generating plural detection signals, which have different phase differences and which respectively correspond to plural ranges aligned in one direction along a movement direction of a detection target having a magnetic material, based on a change in a magnetic field received from the detection target along with a movement of the detection target.

The position sensor further includes a signal processor acquiring the detection signals from the detector, comparing the detection signals with a threshold value, and specifying a position of the detection target as a position covered by one of the ranges based on a combination of magnitude relations of the detection signals and the threshold value.

Since the detector detects the position under the influence of the magnetic field from the detection target, the detection target does not necessarily need to have a magnet. The number of manufacturing steps, the number of assembling steps and the number of components do not increase, and the detection positional error caused by a magnet does not occur. The signal processor detects a position of the detection target in any one of plural ranges. Therefore, a detection positional error due to signal misalignment or A/D conversion error being included in the signal does not occur. Therefore, it is possible to suppress the generation of a detection positional error.

Hereinafter, embodiments of the present disclosure will be described, with reference to the drawings. In the following embodiments, the same reference numeral is given to the same or equivalent parts in the drawings.

### First Embodiment

A first embodiment of the present disclosure will be described below with reference to the drawings. A position sensor according to the present embodiment detects the range (state) that covers the position of a detection target and outputs a signal according to that range.

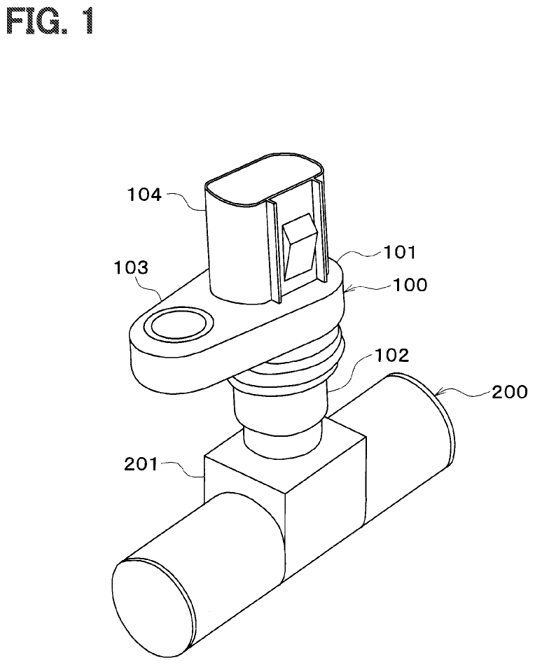

As illustrated in FIG. 1, a position sensor 100 detects the position of a shaft 200 in conjunction with an operation of a vehicle shift position as a detection target. Specifically, the position sensor 100 detects a signal based on the position of a protrusion part 201 on the shaft 200 to acquire the state of the shaft 200.

The state of the shaft 200 means the position of the shaft 200 when the shift position is operated by a user. For example, the shaft 200 is moved in conjunction with a parking position of the shift position. As illustrated in FIG. 1, when the shift position is operated to be the parking position, the shaft 200 is axially moved. The shaft 200 thus reflects the state of the parking position. The position sensor 100 detects the position of the shaft 200 right before the protrusion part 201.

Meanwhile, when the shift position is operated to be a position other than the parking position, the shaft 200 reflects the state of that shift position other than the parking position. In this case, the position sensor 100 detects the position of the protrusion part 201 or the position of the shaft 200 right after the protrusion part 201. The shaft 200 may be moved in conjunction with a position other than the parking position.

The shaft 200 is entirely made of a magnetic material, for example. In the shaft 200, a surface of the protrusion part 201 opposing the position sensor 100 may be made of a magnetic material and other portions may be made of other metal materials.

The position sensor 100 includes a case 101 formed by molding a resin material such as PPS. The case 101 includes a distal end part 102 on a side of the shaft 200, a flange 103 fixed to a peripheral mechanism, and a connector 104 to which a harness is connected. A sensing part is disposed within the distal end part 102.

The position sensor 100 is fixed via the flange 103 to the peripheral mechanism so that the distal end part 102 has a predetermined gap to the protrusion part 201 of the shaft 200. Consequently, the shaft 200 moves with respect to the position sensor 100.

Although not illustrated, the position sensor 100 may be fixed to the peripheral mechanism so as to detect the position of a valve operating in conjunction with the shaft 200. The movement direction of the shaft 200 is not limited to a straight direction and a reciprocal direction. The shaft 200 may rotate or reciprocate at a specific angle. As described above, the position sensor 100 can be used to detect the state of a movable component moving in conjunction with the operation of the vehicle shift position such as movement and rotation.

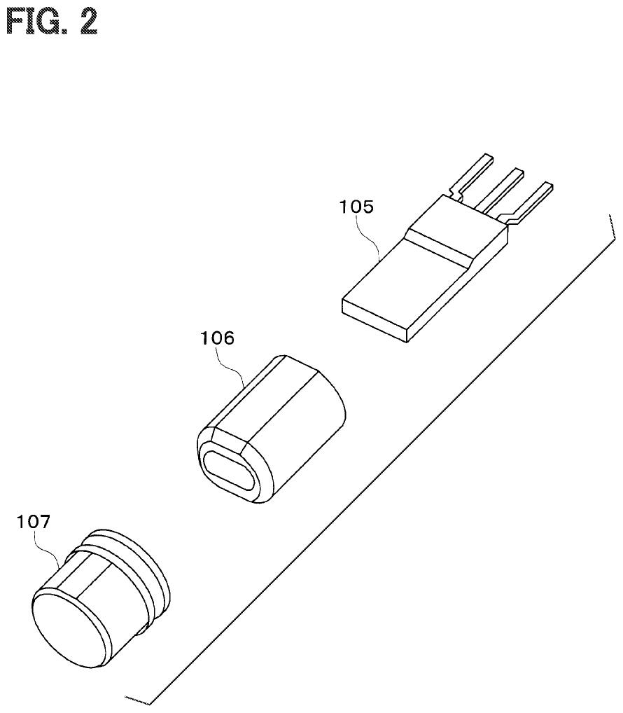

The position sensor 100 may employ a magnetic detection system using a magnetic resistance element or a magnetic detection system using a Hall-effect sensor. As illustrated in FIG. 2, in the case of the magnetic detection system using a magnetic resistance element, the position sensor 100 includes a mold IC 105, a magnet 106, and a holder 107. These components are housed in the distal end part 102 of the case 101. The mold IC 105 is inserted into the magnet 106 formed in a hollow cylindrical shape. The magnet 106 is inserted into the holder 107 formed in a cylindrical shape with a bottom.

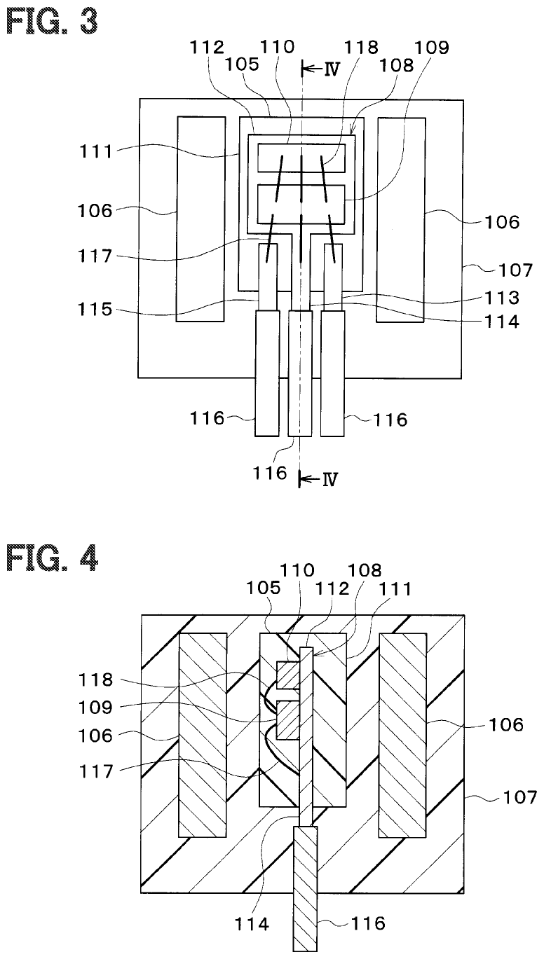

As illustrated in a schematic plan view of FIG. 3 and a schematic cross-sectional view of FIG. 4, the mold IC 105, the magnet 106, and the holder 107 are integrated with each other. The main part of the mold IC 105 is disposed in a hollow part of the magnet 106. The holder 107 fixes the positions of the mold IC 105 and the magnet 106.

The mold IC 105 includes a lead frame 108, a processing circuit chip 109, a sensor chip 110, and a mold resin 111. The lead frame 108 includes a plate-like island 112 and a plurality of leads 113 to 115. The island 112 is disposed so that its flat surface is vertical to the movement direction of a detection target.

The leads 113 to 115 include a power supply terminal 113 to which a power supply voltage is applied, a ground terminal 114 to which a ground voltage is applied, and an output terminal 115 for outputting a signal. That is, the leads 113 to 115 are three leads for a power supply, ground, and a signal, respectively. A terminal 116 is connected to a distal end of each of the leads 113 to 115. The terminal 116 is disposed in the connector 104 of the case 101. The terminal 116 is also connected to a harness.

In the present embodiment, the ground lead 114 of the leads 113 to 115 is integrated with the island 112. The island 112 may be completely separated from all the leads 113 to 115.

The processing circuit chip 109 and the sensor chip 110 are mounted on the island 112 by an adhesive or the like. The processing circuit chip 109 includes a circuit unit that processes signals from the sensor chip 110. The sensor chip 110 includes a magnetic resistance element whose resistance value changes when being externally affected by a magnetic field. The magnetic resistance element is, for example, AMR, GMR, or TMR. The leads 113 to 115 are electrically connected via wires 117 to the processing circuit chip 109. The processing circuit chip 109 is electrically connected via wires 118 to the sensor chip 110.

The mold resin 111 seals the island 112, parts of the leads 113 to 115, the processing circuit chip 109, and the sensor chip 110. The mold resin 111 is molded in a shape fixed in the hollow part of the magnet 106.

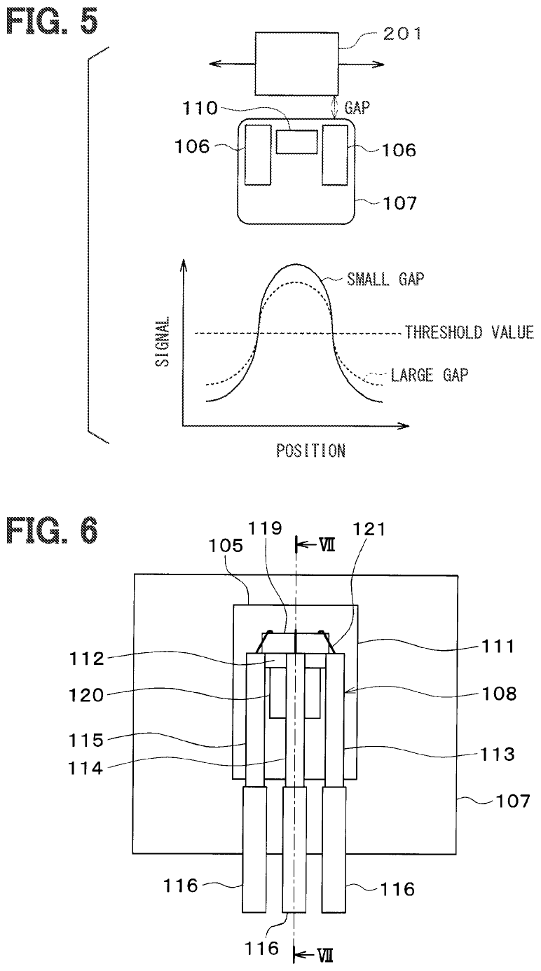

A detection signal generated by the magnetic detection system using a magnetic resistance element will be described. As illustrated in FIG. 5, the holder 107 is disposed with a predetermined gap to the protrusion part 201 that is a detection target. When the protrusion part 201 moves relative to the holder 107, a detection signal is maximized at the center in the movement direction of the protrusion part 201. When the gap increases, the amplitude of the detection signal decreases. On the other hand, when the gap decreases, the amplitude of the detection signal increases. It is possible to detect the position of the protrusion part 201 by setting a threshold of the detection signal.

FIG. 5 illustrates only the relationship between the movement of the protrusion part 201 and a detection signal from a magnetic detection element. The detection signal is generated by outputs of plural magnetic resistance elements, which will be described later.

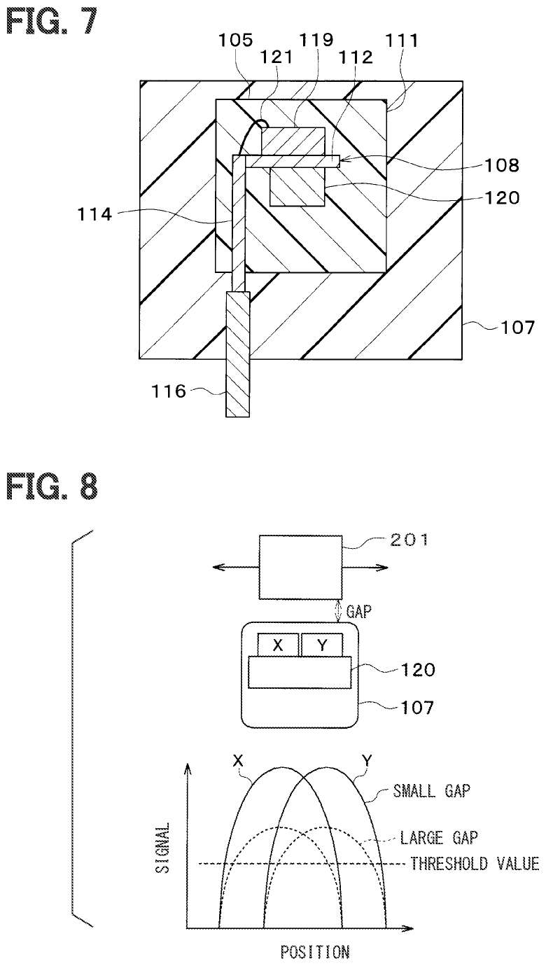

When the magnetic detection system using a Hall-effect sensor is used, the mold IC 105 is inserted and fixed into the holder 107 as illustrated in a schematic plan view of FIG. 6 and a schematic cross-sectional view of FIG. 7. The mold IC 105 includes the lead frame 108, an IC chip 119, a magnet 120, and the mold resin 111.

The island 112 of the lead frame 108 is disposed so that the flat surface of the island 112 is parallel to the movement direction of a detection target. The leads 113 to 115 each are disposed to be vertical to the movement direction of the detection target. The ground lead 114 is integrated with the island 112 so as to form a right angle with the island 112. A terminal 116 is connected to a distal end of each of the leads 113 to 115.

The IC chip 119 includes a plurality of Hall-effect sensors and a signal processing circuit. That is, the magnetic detection system using a Hall-effect sensor employs a one chip configuration. The magnet 120 is fixed on a surface of the island 112 opposite to a surface on which the IC chip 119 is disposed. The leads 113 to 115 each are electrically connected via wires 121 to the IC chip 119. The mold resin 111 is molded in a shape fixed in the hollow part of the holder 107.

A detection signal generated by the magnetic detection system using a Hall-effect sensor will be described. As illustrated in FIG. 8, in a case where two Hall-effect sensors (X, Y) are disposed on the magnet 120, for example, when the protrusion part 201 moves relative to the holder 107, each detection signal is maximized according to the position of each Hall-effect sensor (X, Y). The relationship between a gap and the amplitude of a detection signal is similar to that of the magnetic detection system using a magnetic resistance element. It is possible to detect the position of the protrusion part 201 by setting a threshold of each detection signal.

The present embodiment employs the magnetic detection system using a magnetic resistance element. The magnetic resistance element that detects a magnetic vector has a merit of being capable of cancelling a precision error due to a variation in gap. In addition, the magnetic resistance element also has a merit of being capable of reducing or cancelling the effect of stress generated in the sensor chip 110. Consequently, it is possible to achieve detection with high precision.

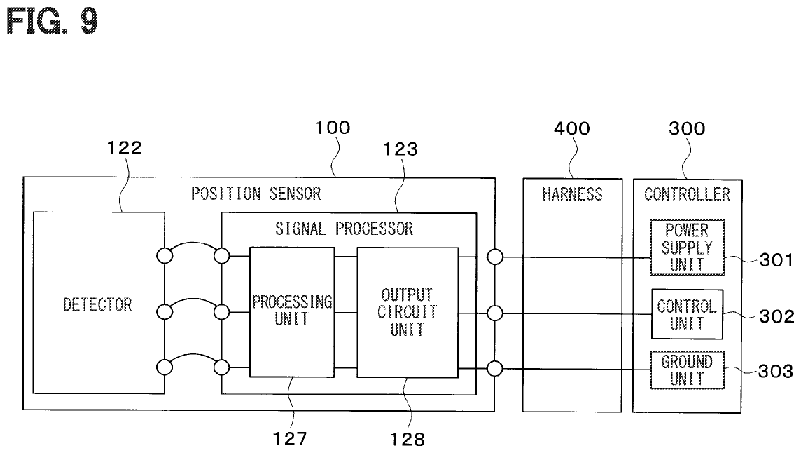

Next, a circuit configuration in the sensor chip 110 and the processing circuit chip 109 will be described. As illustrated in FIG. 9, the position sensor 100 is electrically connected via a harness 400 to a controller 300. As the mold IC 105 has three leads 113 to 115 as described above, the harness 400 includes three wires.

The controller 300 is, for example, a transmission controller (TCU). The controller 300 includes a power supply unit 301, a control unit 302, and a ground unit 303. The power supply unit 301 is a circuit unit that supplies a power supply voltage to the position sensor 100. The control unit 302 is a circuit unit that executes predetermined control according to an output signal input from the position sensor 100. The ground unit 303 is a circuit unit that sets a ground voltage of the position sensor 100. The controller 300 may be configured as an electronic controller (ECU).

The position sensor 100 includes a detector 122 and a signal processing unit 123. The detector 122 is disposed in the sensor chip 110. The signal processing unit 123 is disposed in the processing circuit chip 109. The detector 122 and the signal processing unit 123 operate based on a power supply voltage and a ground voltage supplied from the controller 300.

The detector 122 generates plural detection signals corresponding to plural ranges along a movement direction of the shaft 200 and having different phase differences, based on a change in the magnetic field received from the shaft 200. The plural ranges along the movement direction of the shaft 200 are not arranged along the movement direction of the shaft 200 in parallel, but are arranged in one direction along the movement direction of the shaft 200 in series.

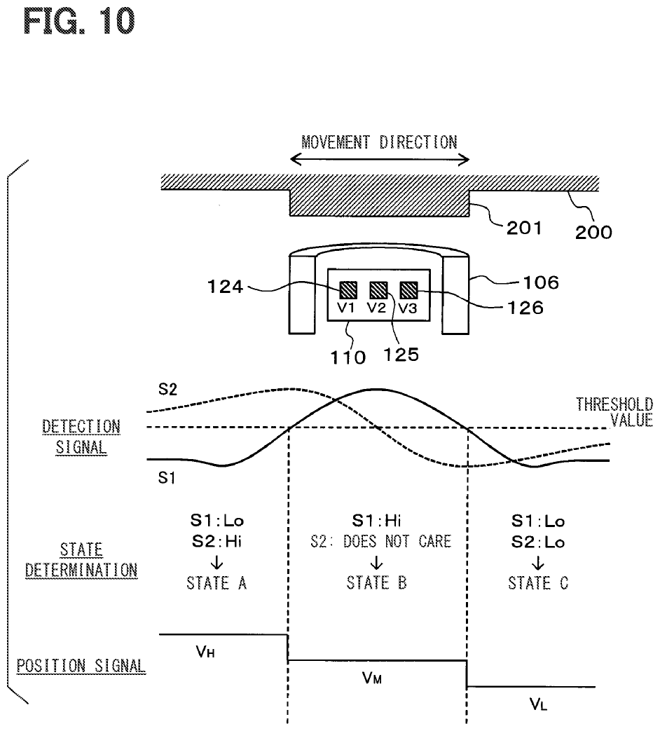

As illustrated in FIG. 10, the detector 122 includes three sets of the element pairs, that is, a first magnetic resistance element pair 124, a second magnetic resistance element pair 125, and a third magnetic resistance element pair 126 whose resistance values change depending on the movement of the protrusion part 201.

The first magnetic resistance element pair 124, the second magnetic resistance element pair 125, and the third magnetic resistance element pair 126 are disposed so that the second magnetic resistance element pair 125 is disposed between the first magnetic resistance element pair 124 and the third magnetic resistance element pair 126 in the movement direction of the protrusion part 201. The second magnetic resistance element pair 125 is disposed to be sandwiched between the first magnetic resistance element pair 124 and the third magnetic resistance element pair 126. A bias magnetic field is applied to the second magnetic resistance element pair 125 along the central axis of the magnet 106. A bias magnetic field is applied to the first magnetic resistance element pair 124 and the third magnetic resistance element pair 126 so as to surround ends of the magnet 106.

Each of the magnetic resistance element pairs 124 to 126 is configured as a half bridge circuit in which two magnetic resistance elements are serially connected between a power supply and a ground. Each of the magnetic resistance element pairs 124 to 126 detects a change in resistance value when the two magnetic resistance elements are affected by a magnetic field according to the movement of the protrusion part 201. Each of the magnetic resistance element pairs 124 to 126 outputs a voltage at the intermediate point of the two magnetic resistance elements as a waveform signal based on the change in resistance value. In the configuration where the magnetic resistance element pairs 124 to 126 are driven by a current source, a voltage across both ends of each of the magnetic resistance element pairs 124 to 126 is formed as a waveform signal.

The detector 122 also includes first to fourth operational amplifiers (not shown) in addition to the magnetic resistance element pairs 124 to 126. It is assumed that the intermediate potential at the intermediate point of the first magnetic resistance element pair 124 is defined as V1 and the intermediate potential at the intermediate point of the second magnetic resistance element pair 125 is defined as V2. The first operational amplifier is a differential amplifier configured to calculate (V1−V2) and output the result as R1. It is assumed that the intermediate potential at the intermediate point of the third magnetic resistance element pair 126 is defined as V3. The second operational amplifier is a differential amplifier configured to calculate (V2−V3) and output the result as R2.

The third operational amplifier is a differential amplifier configured to receive the intermediate potential V1 from the intermediate point of the first magnetic resistance element pair 124, receive the intermediate potential V3 from the intermediate point of the third magnetic resistance element pair 126, calculate (V1−V3), and output the result as S1. For example, the signal S1 has a waveform whose amplitude is maximum at the center in the movement direction of the protrusion part 201 on the shaft 200 and is minimum as being away from the protrusion part 201.

The fourth operational amplifier is a differential amplifier configured to receive an input of R1 (=V1−V2) from the first operational amplifier, receive an input of R2 (=V2−V3) from the second operational amplifier, calculate R2−R1, and output the result as S2 (=(V2−V3)−(V1−V2)). The signal S2 has a waveform according to a recess and protrusion structure of the protrusion part 201 on the shaft 200. For example, the signal S2 has a waveform whose amplitude is maximum at one edge portion of the protrusion part 201 on the shaft 200 where a recess changes to a protrusion and is minimum at the other edge portion of the protrusion part 201 on the shaft 200 where the protrusion changes to the recess. The signal S2 has a waveform with a phase difference from the signal S1.

The detector 122 generates and acquires the signal S1 (=V1−V3) and the signal S2 (=(V2−V3)−(V1−V2)) from the outputs of the magnetic resistance element pairs 124 to 126. The detector 122 each outputs the signals S1 and S2 to the signal processing unit 123 as detection signals.

The signal processing unit 123 in FIG. 9 acquires detection signals from the detector 122, and identifies the position of the shaft 200 as the position of any one of the plural ranges of the shaft 200 based on a combination of magnitude relationship between each detection signal and a threshold value. The signal processor 123 outputs the position of the shaft 200 to the controller 300. The signal processor 123 includes a processing unit 127 and an output circuit unit 128.

The processing unit 127 receives detection signals from the detector 122, and specifies the position of the protrusion part 201 based on the detection signals. The processing unit 127 has a common threshold value for each detection signal.

The processing unit 127 compares the signals S1 and S2, which are detection signals, to the threshold value. If the signals S1 and S2 are larger than the threshold value, the processing unit 127 determines such a state as Hi. On the other hand, if the signals S1 and S2 are smaller than the threshold, the processing unit 127 determines such a state as Lo. The processing unit 127 determines the range of the shaft 200 detected by the detector 122 based on a Hi/Lo combination of the signals S1 and S2.

Specifically, when the signal S1 is Lo and the signal S2 is Hi as illustrated in FIG. 10, the detector 122 detects the shaft 200 on the left side of the protrusion part 201 on the drawing. That is, the processing unit 127 specifies the position of the shaft 200. The state of the shaft 200 when a position in such a range is specified is referred to as “state A”.

Similarly, when the signal S1 is Hi, the detector 122 detects the protrusion part 201 on the shaft 200. In this case, it does not care whether the signal S2 is Hi or Lo. The state of the shaft 200 when a position in such a range is specified is referred to as “state B”.

When the signal S1 is Lo and the signal S2 is also Lo, the detector 122 detects the shaft 200 on the right side of the protrusion part 201 on the drawing. The state of the shaft 200 when a position in such a range is specified is referred to as “state C”. As described above, the processing unit 127 specifies the position of the shaft 200 as a position in one of the ranges in the movement direction of the shaft 200.

The output circuit unit 128 outputs a position signal, which indicates any one of the states A to C, to the controller 300 based on a determination result of the processing unit 127. The output circuit unit 128 acquires information of the states A to C, which is determined based on the detection signal from the processing unit 127. The output circuit unit 128 outputs a position signal with a value corresponding to a range that covers a specified position among discrete values set in plural ranges to the controller 300.

In the present embodiment, position signals with discrete values are voltage signals with different voltage values. The voltage values respectively representing the states A to C are set to discrete values so as not to overlap. For example, the state A is set to V_{H}, the state B is set to V_{M}, and the state C is set to V_{L}. A magnitude relationship of those voltage values is V_{H}>V_{M}>V_{L}. It is only required that the discrete values do not overlap among the states A to C. Consequently, the discrete values may be set as any voltage value in a predetermined voltage range. The predetermined voltage range may be identical among the states A to C such as within 1V. Alternatively, the predetermined voltage range may be different among the states A to C such as the state A is within 1V and the state B is within 2V.

As illustrated in FIG. 10, when the protrusion part 201 moves in the movement direction of the shaft 200, a position signal has a discrete voltage value changing stepwise. If the voltage value of the position signal increases or decreases momentarily due to a noise, the position signal may reach a voltage value indicating other states. As the control unit 302 of the controller 300 reads a voltage value for a predetermined time, the influence of the noise can be substantially eliminated. That is, the position sensor 100 can output a signal with high noise resistance. The configuration of the position sensor 100 according to the present embodiment has been described above.

The control unit 302 of the controller 300 receives a position signal from the position sensor 100 and uses the signal for desired control. Examples of the desired control include control of switching on and off a parking lamp in a meter device of a vehicle, control of permitting or prohibiting other control depending on whether a shift position is a parking position, control of not using the position sensor 100 in case of fault, and control of switching on a fault lamp.

In some cases, the control unit 302 inputs a signal other than the position signal. This type of signal other than the position signal is originally difficult to be generated as an output of the position sensor 100. In this case, it is assumed that the signal is generated caused by a fault other than a fault of the position sensor 100. For example, the fault is assumed to be a fault of a communication device such as the harness 400. The controller 300 is thus capable of detecting the fault of the communication device.

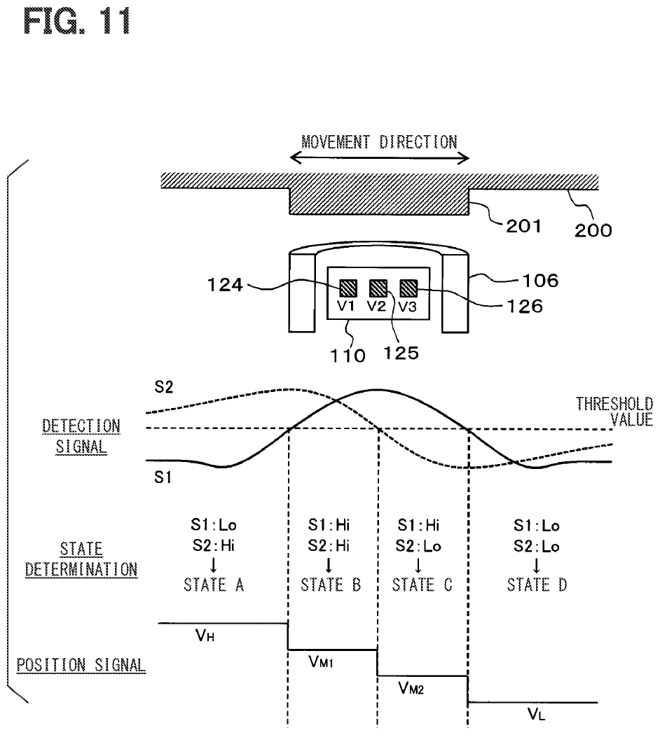

As illustrated in FIG. 11, four states can be determined from detection signals in a modified example. A case where the signal S1 is Lo and the signal S2 is Hi is referred to as “state A”. A case where the signals S1 and S2 are Hi is referred to as “state B”. A case where the signal S1 is Hi and the signal S2 is Lo is referred to as “state C”. A case where the signal S1 and S2 are Lo is referred to as “state D”. In this case, four discrete voltage values (V_{H}>V_{M1}>V_{M2}>V_{L}) are respectively set in these four states as illustrated in FIG. 11.

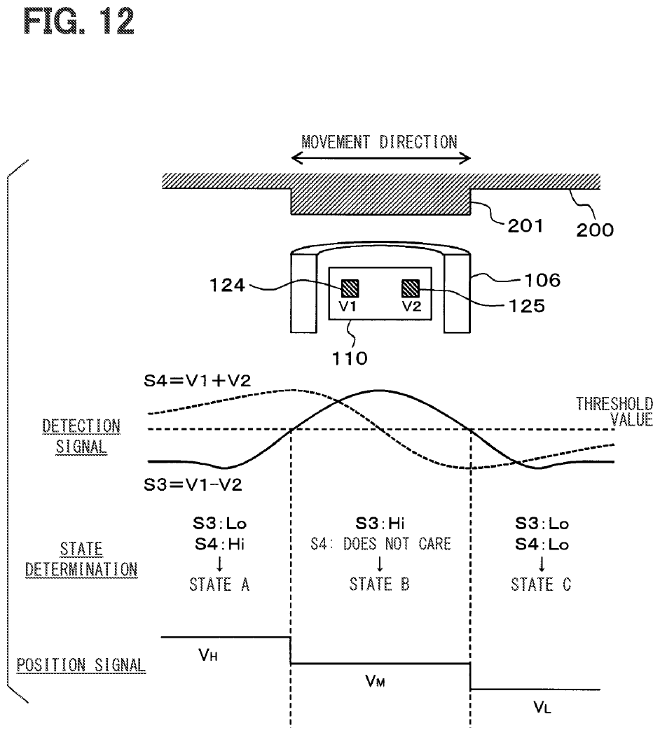

As illustrated in FIG. 12, three states can be determined from the first magnetic resistance element pair 124 and the second magnetic resistance element pair 125 in a modified example. The processing unit 127 generates and acquires the signal S3 (=V1−V2) and the signal S3 (=V1+V2) from the outputs of the magnetic resistance element pairs 124, 125. It is possible to acquire two detection signals having a distinct phase difference also with this computation processing.

The processing unit 127 determines a case where the signal S3 is Lo and the signal S4 is Hi as “state A”. The processing unit 127 determines a case where the signal S3 is Hi as “state B”. The processing unit 127 determines a case where the signal S3 is Hi and the signal S4 as “state C”. In this case, three states are output as three discrete voltage values (V_{H}, V_{M}, V_{L}).

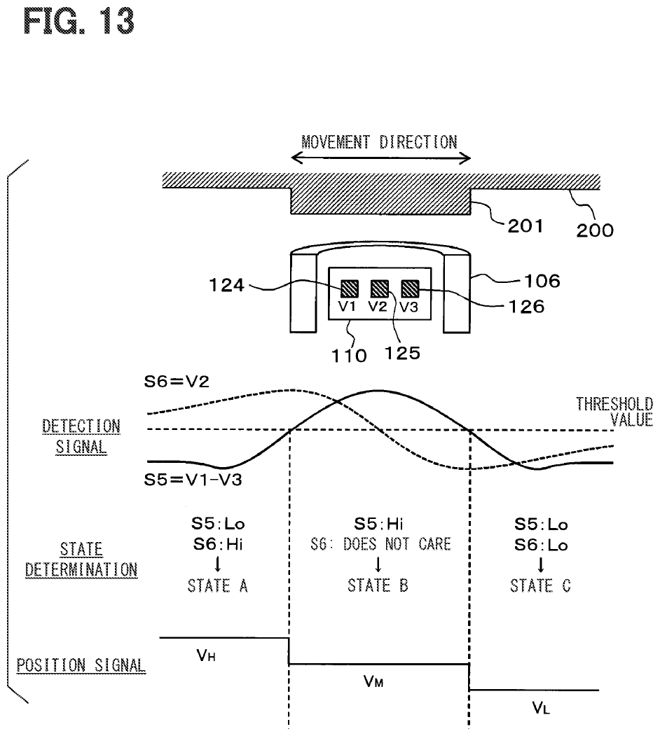

As shown in FIG. 13, the processing unit 127 generates and acquires the signal S5 (=V1−V3) and the signal S6 (=V2) from the outputs of three magnetic resistance element pairs 124 to 126 in a modified example. Therefore, it is possible to determine three states from the first magnetic resistance element pair 124 and the second magnetic resistance element pair 125, which are two element pairs. The state determination in this modified example is similar to FIG. 12.

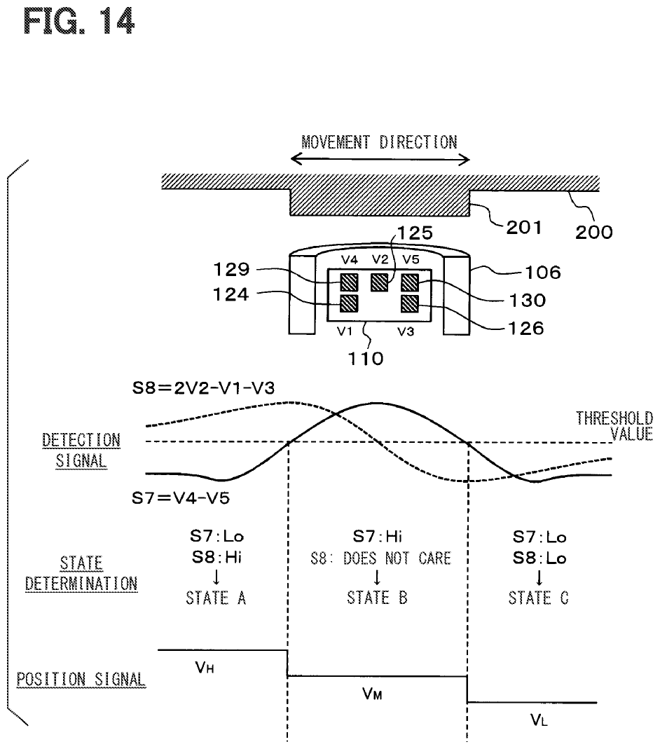

As shown in FIG. 14, the detector 122 includes the first magnetic resistance element pair 124, the second magnetic resistance element pair 125, the third magnetic resistance element pair 126, the fourth magnetic resistance element pair 129, and the fifth magnetic resistance element pair 130, which are five element pairs, in a modified example. The magnetic resistance element pairs 124 to 126, 129, 130 respectively output midpoint potentials V1 to V5.

In this case, the processing unit 127 generates and acquires the signal S7 (=V4−V5) and the signal S8 (=2V2−V1−V3) from the outputs of the magnetic resistance element pairs 124 to 126, 129, 130. As similar to the example in FIG. 12, three states can be determined from the signals S7, S8.

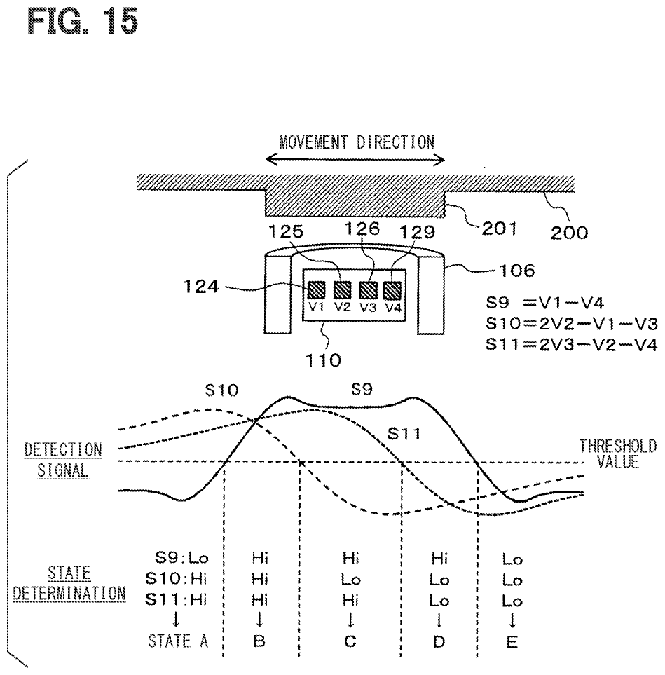

As shown in FIG. 15, the detector 122 includes four magnetic resistance element pairs 124 to 126, 129 in a modified example. In this case, the processing unit 127 generates and acquires three signals S9 (=V1−V4), S10 (=2V2−V1−V3) and S11 (=2V3−V2−V4) from the outputs of four magnetic resistance element pairs. Three detection signals with different phase difference can be acquired from the outputs of the four sets of the element pairs.

The processing unit 127 determines a case where the signal S9 is Lo, the signal S10 is Hi and the signal S11 is Hi as “state A”. The processing unit 127 determines a case where the signal S9 is Hi, the signal S10 is Hi and the signal S11 is Hi as “state B”. The processing unit 127 determines a case where the signal S9 is Hi, the signal S10 is Lo and the signal S11 is Hi as “state C”. The processing unit 127 determines a case where the signal S9 is Hi, the signal S10 is Lo and the signal S11 is Lo as “state D”. The processing unit 127 determines a case where the signal S9 is Lo, the signal S10 is Lo and the signal S11 is Lo as “state E”. In this case, five states are output as five discrete voltage values as described above.

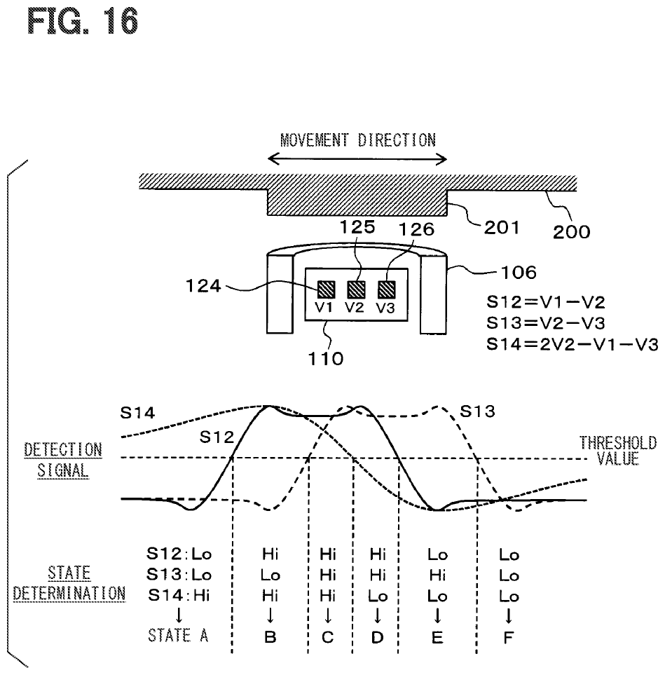

As shown in FIG. 16, the detector 122 includes three sets of magnetic resistance element pairs 124 to 126 in a modified example. In this case, the processing unit 127 generates and acquires the signal S12 (=V1−V2), the signal S13 (=V2−V3), and the signal S14 (=2V2−V1−V3) from the outputs of three sets of element pairs. Three detection signals with different phase differences can be obtained from the outputs of the three sets of the element pairs.

The processing unit 127 determines six states A to F based on a combination of Hi/Lo of three signals S12, S13 and S14. In this case, six states are output as six discrete voltage values as described above.

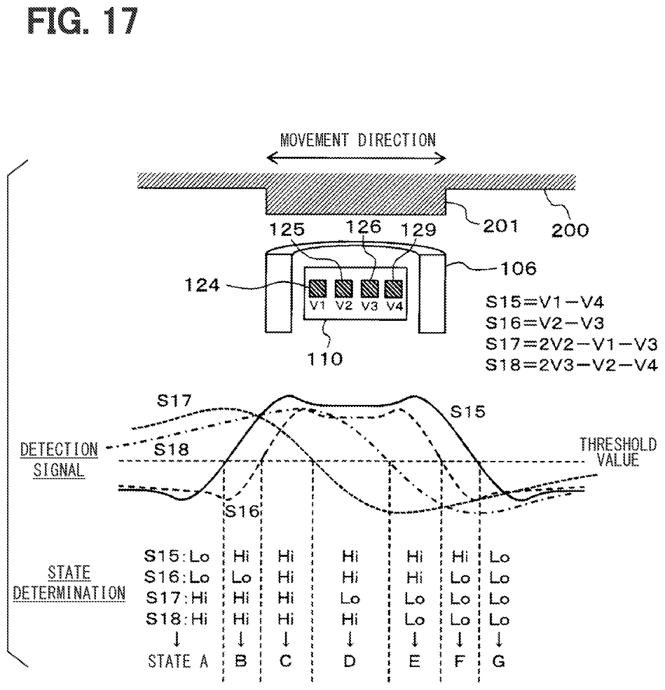

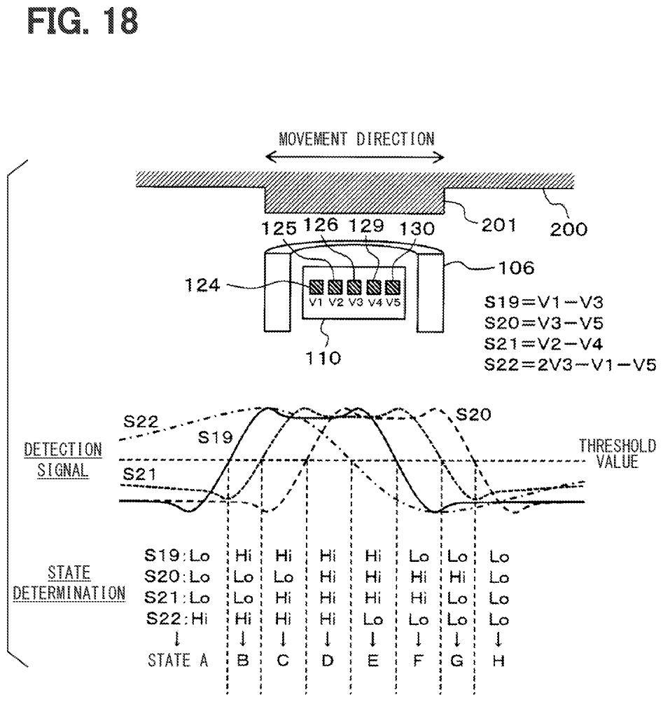

As shown in FIG. 17, the detector 122 includes four magnetic resistance pairs 124 to 126, 129 in a modified example. The processing unit 127 generates and acquires four signals S15 (=V1−V4), S16 (=V2−V3), S17 (=2V2−V1−V3) and S18 (=2V3−V2−V4) from the outputs of four sets of element pairs. Four detection signals having different phase differences can be acquired from the outputs of the four sets of the element pairs.

As similar to the above modified example, the processing unit 127 determines seven states A to G based on a combination of Hi/Lo of four signals S15, S16, S17 and S18. In this case, seven states are output as seven discrete voltage values.

As shown in FIG. 17, the detector 122 includes five magnetic resistance pairs 124 to 126, 129, 130 in a modified example. The processing unit 127 generates and acquires four signals S19 (=V1−V3), S20 (=V3−V5), S21 (=V2−V4) and S21 (=2V3−V1−V5) from the outputs of five sets of element pairs. Four detection signals with different phase differences can be acquired from the outputs of the five sets of element pairs.

As similar to the above modified example, the processing unit 127 determines eight states A to H based on a combination of Hi/Lo of four signals S19, S20, S21 and S22. In this case, eight states are output as eight discrete voltage values.

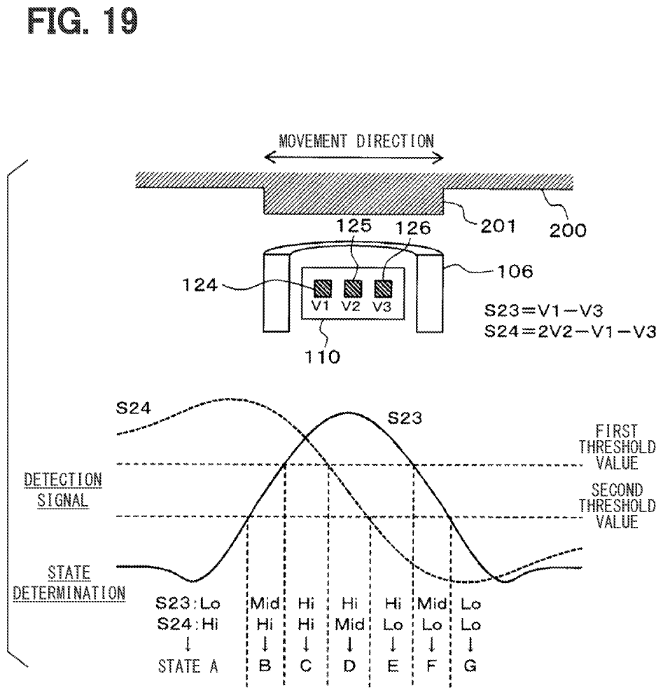

As shown in FIG. 19, the detector 122 includes three magnetic resistance element pairs 124 to 126 in a modified example. The processing unit 127 generates and acquires two signals S23 (=V1−V3) and S24 (=2V2−V1−V3) from the outputs of three sets of element pairs. Two detection signals with different phase differences can be acquired from the outputs of three sets of element pairs.

The processing unit 127 includes a first threshold value and a second threshold value. The second threshold value is smaller than the first threshold value. The processing unit 127 compares each signal S23, S24 to each threshold value. In this case, the processing unit 127 determines a signal as Hi when the signal is larger than the first threshold value, determines a signal as Mid when the signal is between the first threshold value and the second threshold value, and determines the signal as Lo when the signal is smaller than the second threshold value.

The processing unit 127 determines a case where the signal S23 is Lo and the signal S24 is Hi as “state A”. The processing unit 127 determines a case where the signal S23 is Mid and the signal S24 is Hi as “state B”. The processing unit 127 determines a case where the signal S23 is Hi and the signal S24 is Hi as “state C”. The processing unit 127 determines a case where the signal S23 is Hi and the signal S24 is Mid as “state D”. The processing unit 127 determines a case where the signal S23 is Hi and the signal S24 is Lo as “state E”. The processing unit 127 determines a case where the signal S23 is Mid and the signal S24 is Lo as “state F”. The processing unit 127 determines a case where the signal S23 is Lo and the signal S24 is Lo as “state G”.

It is also possible to change the number of states for determination by using plural threshold values. The number of threshold values is not limited to two. Three or more threshold values may also be provided. In this case, seven states are output as seven discrete voltage values as described above.

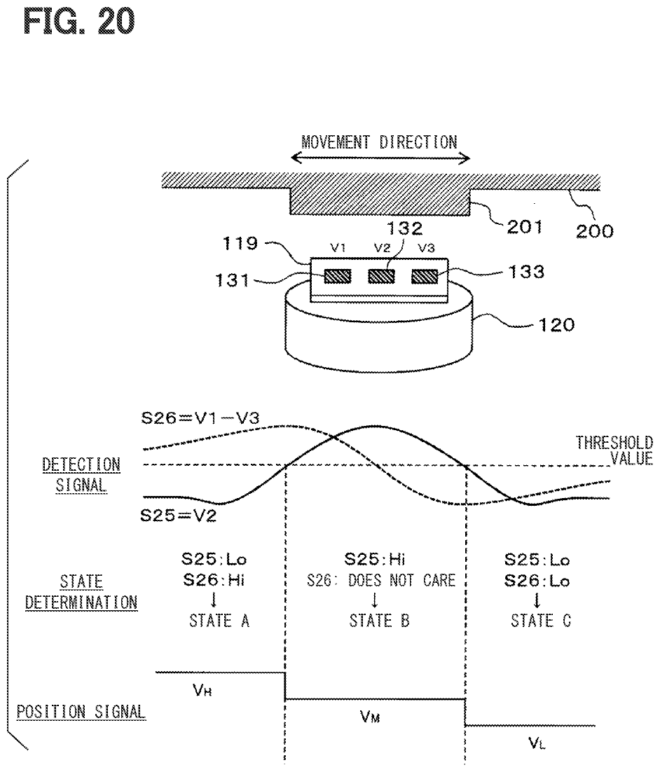

As illustrated in FIG. 20, the detector 122 may be configured to detect a change in the magnetic field along with the movement of the shaft 200 by three Hall-effect sensors 131 to 133 arranged on the magnet 120. The processing unit 127 generates and acquires the signal S25 (=V2) and the signal S26 (=V1−V3) from the outputs of the magnetic resistance element pairs 124, 125. Two detection signals with different phase differences can be acquired from the respective outputs of three Hall-effect sensors 131 to 133.

The processing unit 127 determines three states A to C based on a combination of Hi/Lo of two signals S25 and S26, as similar to the above modified example. In this case, three states are output as three discrete voltage values as described above.

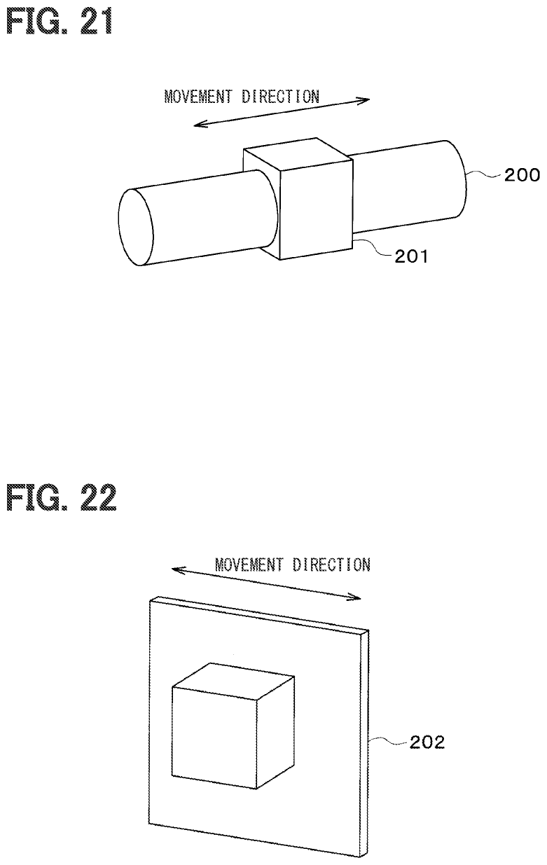

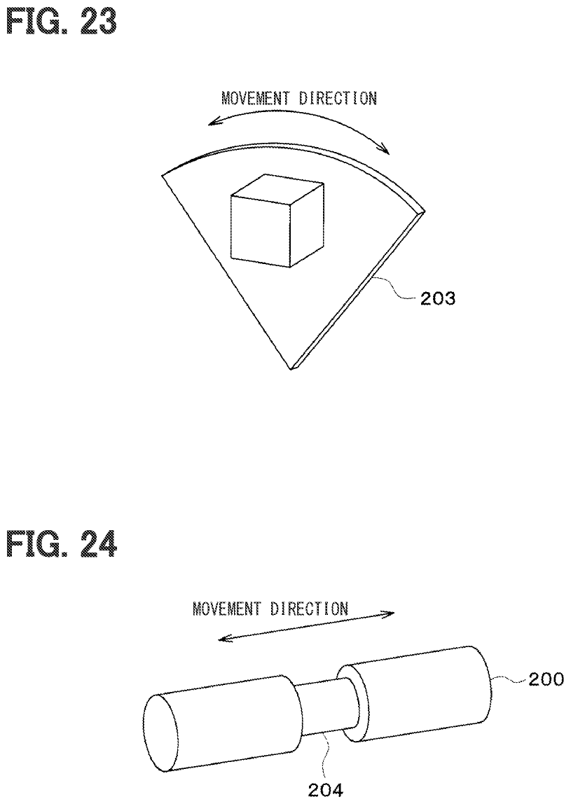

As illustrated in FIG. 21, the shaft 200 may have a shape in which a cylinder is inserted into a rectangular block in a modified example. As illustrated in FIG. 22, the detection target may be a plate member 202 in which a square block is provided on a planar section of a square plate, in replacement of the shaft 200. As illustrated in FIG. 23, the detection target may be a fan-shaped member 203 provided with a square block on a flat portion of a fan-shaped plate.

The detection target is provided with a reference section between a first moveable section and a second moveable section. The detection target is configured such that the structural change is similar to the transition from the first moveable section to the reference section and the transition from the second moveable section to the reference section. In the examples respectively illustrated in FIGS. 21 to 23, the reference section protrudes from the first moveable section and the second moveable section. A transition from the first moveable section to the reference section and a transition from the second moveable section to the reference section correspond to a transition from a recess state to a protrusion state. The detection target may have a shape that divides a detection range into plural ranges.

As described above, in the present embodiment, the position sensor 100 specifies any one of plural ranges of the shaft 200 as the detection target, and outputs the position signal corresponding to a position in the specified range. In this configuration, the detector 122 detects a position under the influence of the magnetic field from the shaft 200, it is not necessary to provide a magnet as the detection target. Therefore, there is no increase in the number of manufacturing steps, the number of assembling steps and the number of components for the detection target. The detection positional error caused by a magnet as the detection target does not occur.

The signal processor 123 detects a position of the protrusion portion 201 as the detection target, as the state of the shaft 200. Therefore, the detection positional error due to the signal misalignment or A/D conversion error included in the position signal does not occur. Therefore, it is possible to suppress the generation of a detection positional error.

The signal processor 123 is configured such that each state is output as a discrete voltage value. A read margin is provided in the controller 300, and thus the states are not determined incorrectly in superimposed noise and high noise resistance is achieved. The detection positional error due to noise can be reduced so as to enhance the robustness against the detection positional error. It is thus possible to ensure the precision of the output of the position sensor 100.

The shaft 200, the plate member 202 and the fan-shaped member 203 correspond to the detection target, and the controller 300 corresponds to an external device.

### Second Embodiment

In the present embodiment, configurations different from those of the first embodiment are described. As illustrated in FIG. 24, the shaft 200 includes a recess part 204 partially recessed in a radial direction. The processing unit 127 can generate the signals S1 and S2 from the respective detection signals of the magnetic resistance element pairs 124 to 126.

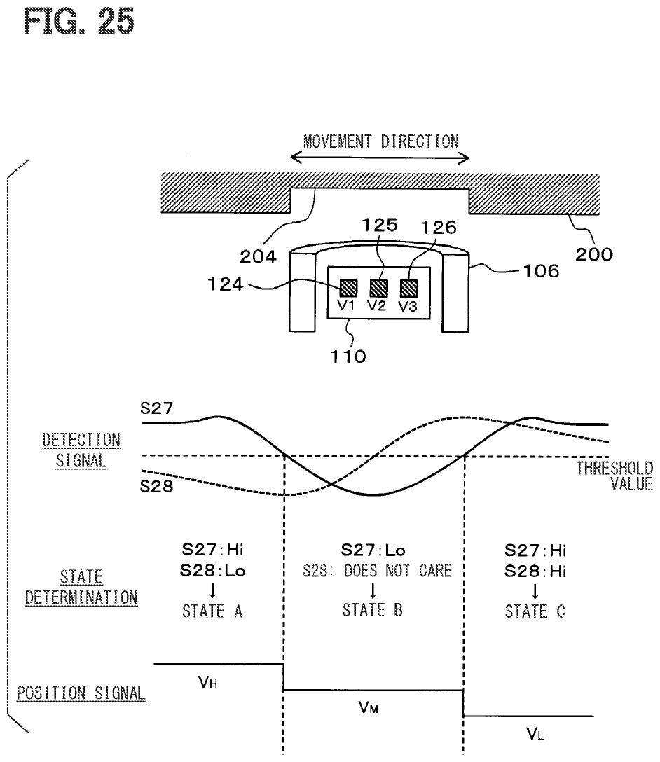

As shown in FIG. 25, a signal S27 (=V1−V3) has a waveform whose amplitude is minimum as being at the center in the movement direction of the recess part 204 on the shaft 200 and the amplitude is maximum as being away from the recess part 204. A signal S28 (=2V2−V1−V3) has a waveform whose amplitude is minimum at one edge portion of the recess part 204 of the shaft 200 from the protrusion to the recess and the amplitude is maximum at the other edge of the recess part 204 of the shaft 200 from the recess to the protrusion. In other words, the signal is reversed with respect to the example illustrated in, for example, FIG. 10.

As similar to the first embodiment, the processing unit 127 determines three states A to C based on a combination of Hi/Lo of the two signals S27 and S28. In this case, the processing unit 127 outputs three states as three discrete voltage values.

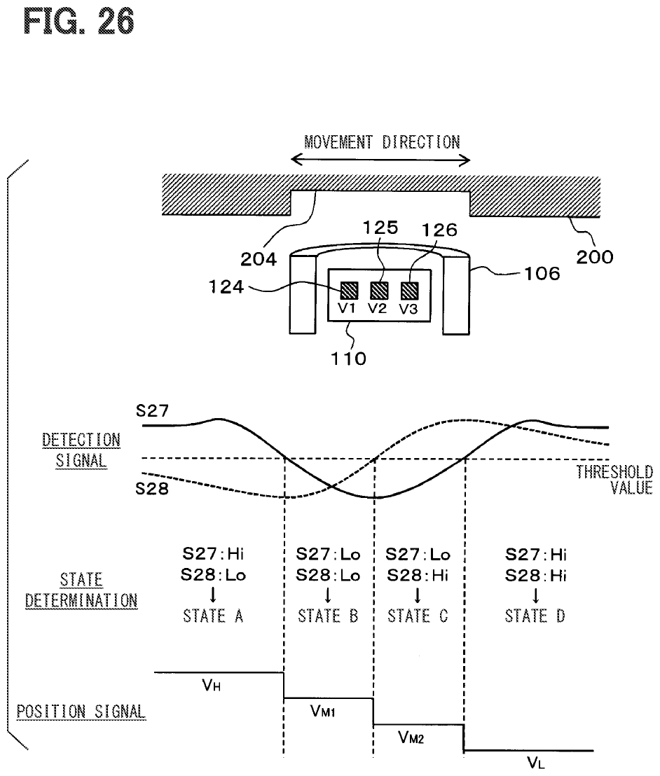

As shown in FIG. 26, four states A to D may be determined based on a combination of Hi/Lo of the two signals S27 and S28 in a modified example. In the case, four states are output as four discrete voltage values. As similar to the first embodiment, the number of signals may be changed, and the number of determination states may be changed.

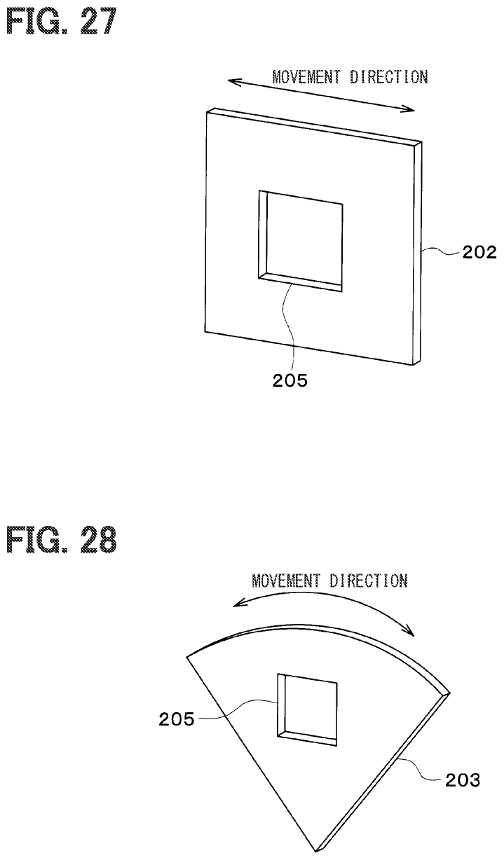

As shown in FIG. 27, the detection target may be provided with a window 205 at the plate member 202 in a modified example. As shown in FIG. 28, the detection target may be provided with the window 205 at the fan-shaped member 203. In the examples shown in FIGS. 24, 27 and 28, the reference section is recessed toward the first moveable section and the second moveable section. The transition from the first moveable section to the reference section and the transition from the second moveable section to the reference section correspond to the transition from the protrusion state to the recess state. The detection target may have a shape that divides a detection range into plural ranges.

### Third Embodiment

In the present embodiment, configurations different from those of the first and second embodiments will be described. In the present embodiment, the output circuit unit 128 outputs pulse signals with different pulse widths to the controller 300 as signals with discrete values. The discrete value signal is a PWM signal. The discrete value is a pulse width value, a signal period, a Duty ratio, or the like.

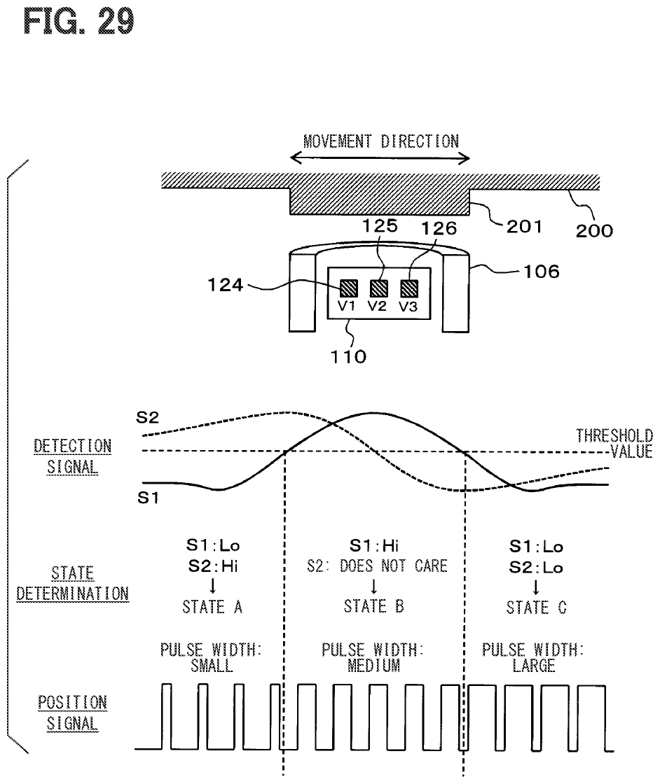

As illustrated in FIG. 29, the pulse width of a signal in the state A is set to be the narrowest and the pulse width of a signal in the state C is set to be the widest. The pulse width of a signal in the state B is set to be intermediate between the pulse width of a signal in the state A and the pulse width of a signal in the state C. It is possible to improve noise resistance as in the first embodiment.

### Other Embodiments

The configuration of the position sensor 100 described in each embodiment is an example. The configuration of the position sensor 100 is not limited to the configurations described above and may be any other configurations that achieve the present disclosure. For example, the position sensor 100 is used not only for vehicles but also for industrial robots and manufacturing facilities as a sensor detecting the positions of movable components.

Although the present disclosure has been made in accordance with the embodiments, it is understood that the present disclosure is not limited to such embodiments and structures. The present disclosure encompasses various modifications and variations within the scope of equivalents. In addition, while the various elements are shown in various combinations and configurations, which are exemplary, other combinations and configurations, including more, less or only a single element, are also within the spirit and scope of the present disclosure.

What is claimed is:

1. A position sensor comprising:
a detector configured to generate a plurality of detection signals, which have a distinct phase difference and which respectively correspond to a plurality of ranges aligned in one direction along a movement direction of a detection target having a magnetic material, based on a change in a magnetic field received from the detection target along with a movement of the detection target; and
a signal processor configured to
acquire the detection signals from the detector,
compare the detection signals with a threshold value, and
specify a position of the detection target as a position covered by one of the ranges, based on a combination of magnitude relations of the detection signals and the threshold value,
wherein the signal processor is configured to set a discrete value to each of the ranges, and
wherein the signal processor is configured to output a position signal, which indicates the discrete value corresponding to the one of the ranges covering the position of the detection target specified by the signal processor, to an external device.

2. The position sensor according to claim 1,
wherein the ranges are a plurality of detection regions aligned in one direction along the movement direction of the detection target.

3. The position sensor according to claim 1,
wherein the position signal being the discrete value is a voltage signal having a distinct voltage value.

4. The position sensor according to claim 1,
wherein the position signal including the discrete value is a pulse signal having a distinct pulse width.

5. The position sensor according to claim 1,
wherein the detector includes a plurality of magnetic resistance element pairs, each magnetic resistance element pair has a resistance value varied with the movement of the detection target.

6. The position sensor according to claim 5,
wherein the detector generates the detection signals based on output from the magnetic resistance element pairs.

7. The position sensor according to claim 1,
wherein the detection target is a moveable component moving in conjunction with an operation of a shift position of a vehicle.
